(19) United States
(12) Patent Application Publication
(10) Pub. No.: US 2007/0294020 A1
(43) Pub. Date: Dec. 20, 2007

(54) Method and Device for the Automatic Longitudinal Control of a Motor Vehicle

(76) Inventor: Thilo Riegel, Stuttgart (DE)

Correspondence Address: KENYON & KENYON LLP, ONE BROADWAY, NEW YORK, NY, 10004, US

(21) Appl. No.: 11/578,198

(22) PCT Filed: Feb. 9, 2005
(86) PCT No.: PCT/EP05/50572

§ 371 Date: Jul. 10, 2007

(30) Foreign Application Priority Data
Apr. 21, 2004 (DE) 10 2004 019 164.6

(51) Int. Cl. G05D 1/02

(52) U.S. Cl. 701/96

(57) ABSTRACT

A device and a method are provided for the automatic longitudinal control of a motor vehicle, which have a distance sensor that measures at least the distance of the following host vehicle to a vehicle traveling in front and/or the relative speed between the two vehicles. From the measured values, it is determined whether the detected, preceding vehicle is stopped, in which case the following vehicle is automatically stopped at a predetermined distance behind the preceding vehicle. When it is detected that the preceding vehicle is driving away again, the driver of the following vehicle must actuate a drive-away confirmation device, the drive-away confirmation device being the brake pedal.

### FIELD OF THE INVENTION

The present invention relates to a device and a method for the automatic longitudinal control of a motor vehicle, which has a distance sensor that measures at least the distance of the following host vehicle to a vehicle traveling in front and/or the relative speed between the vehicles.

### BACKGROUND INFORMATION

The SAE paper 961010 having the title “Adaptive Cruise Control System Aspects and Development Trends,” by Winner, Witte, Uhler and Lichtenberg, published at the SAE International Congress & Exposition, Detroit, Feb. 26-29, 1996, describes an adaptive distance and speed controller which, using radar radiation, measures the distance and relative speed of the preceding vehicle, and as a function thereof, controls the drive devices and deceleration devices of the vehicle in such a way that the vehicle automatically follows behind the preceding vehicle at a predetermined distance. The application limits of this system are defined by the speed, so that such an adaptive distance and speed controller is only useable up to minimal speeds of approximately 40 kilometers per hour. Moreover, it is described that, as a further refinement of such systems, a stop-and-go ACC (automatic cruise control) is implemented which, as a traffic-jam following assistant, is also able to automatically brake the vehicle to a standstill, and when the preceding traffic drives away again, to automatically accelerate the vehicle. Since systems of this kind are designed as driver-supporting assistance systems, a confirmation by the driver is necessary for driving away, since it must be ruled out that a person or object is positioned directly in front of the host vehicle and is not detectable by the distance sensors. If such a traffic-jam following assistant detects that the preceding traffic is driving away again, then the driver of the following host vehicle is prompted to give a drive-away release with the aid of a confirmation. Such drive-away releases may be provided, for instance, by way of an additional control button on the steering wheel or in the instrument panel of the vehicle, or accomplished by a brief actuation of the accelerator.

### SUMMARY

The present invention provides, for a vehicle which has a traffic-jam following assistant for the automatic longitudinal guidance of the vehicle having a stop and drive-away-again function, a drive-away confirmation device that is intuitively operable by the driver, and is safe and harmless for the surroundings, even in the event of an operating error. According to the present invention, this is achieved by a drive-away release implemented by actuating the brake pedal, which is considerably safer with respect to the vehicle surroundings than a brief pressure on the accelerator, since too strong a pressure on the accelerator is evaluated as a driver-actuated override, and the vehicle is accelerated far more sharply than the driver expects, which can lead to a collision risk for the surroundings. Even an inadvertent kick against the accelerator could unintentionally set the host vehicle in motion, since a drive-away release from standstill would thereby be given.

The following vehicle advantageously drives away automatically when the driver displaces the brake pedal from the neutral position.

Moreover, it is advantageous that the following vehicle drives away automatically when the driver releases the brake pedal again.

It is especially advantageous that the following vehicle drives away automatically when a predetermined minimum pedal travel phimin has been exceeded.

The following vehicle advantageously drives away again automatically when a predetermined minimum pedal force on the brake pedal has been exceeded.

Furthermore, it is especially advantageous that the following vehicle drives away automatically when the brake pedal has been actuated longer than a predetermined minimum actuation time.

The method according to the present invention may be implemented in the form of a control element provided for a control unit of a traffic-jam assistant or an adaptive distance and speed control of a motor vehicle. In this context, a program that is executable on a computing element, e.g., on a microprocessor or signal processor, and is suitable for implementing the method according to the present invention, is stored in the control element. In this case, the present invention is thus realized by a program stored in the control element, so that this control element provided with the program represents the present invention in the same manner as the method, for whose implementation the program is suited. In particular, an electric storage medium, e.g., a read-only memory, may be used as a control element.

### BRIEF DESCRIPTION OF THE DRAWINGS

FIG. 1 shows a schematic block diagram of an example embodiment of the device according to the present invention.

FIG. 2 shows a flowchart of an example implementation of the method according to the present invention.

### DETAILED DESCRIPTION

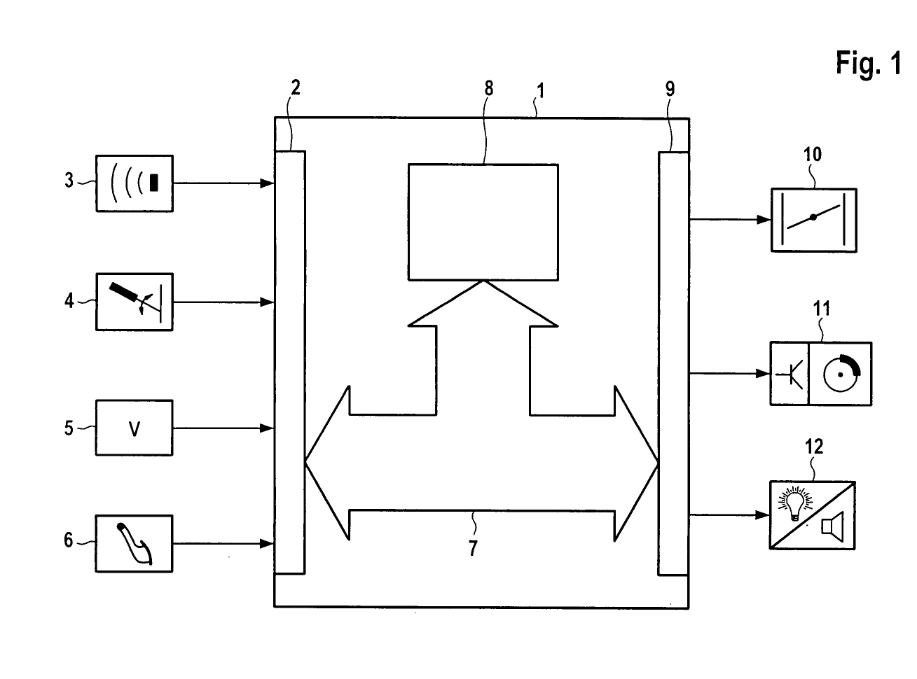

FIG. 1 shows a longitudinal control device 1 which, in stop-and-go traffic, is able to brake the vehicle to be controlled to a standstill, and after detecting that the preceding, stopped traffic is moving again, to automatically set the vehicle to be controlled in motion again. To that end, longitudinal control device 1 has an input circuit 2, by which input signals are able to be supplied to longitudinal control device 1. These input signals come, inter alia, from a distance sensor system 3 which detects preceding vehicles or objects within the sensor detecting range, and ascertains their distance d, relative speed vrel with respect to the following host vehicle, and the azimuth angle of the detected object relative to the extended longitudinal vehicle axis. To that end, one or more sensors may be mounted on the front end of the vehicle. For example, this sensor system may be a radar sensor system, ultrasonic sensor system, video sensor system, laser sensor system and/or a combination of these types of sensors. The distance, relative-speed and azimuth-angle variables ascertained by distance sensor system 3 are fed to input circuit 2 of longitudinal control device 1. Also provided is an operating device 4, by which control signals are able to be supplied to longitudinal control device 1. Thus, with the aid of operating device 4, longitudinal control device 1 may be switched on or off, and specific operating parameters and adjustments may be made and altered, so that the vehicle driver is able to set longitudinal control device 1 according to his/her needs.

Also provided as an input variable is a speed signal V which is generated by a speed sensor 5 that ascertains the speed of the vehicle. With the knowledge of host vehicle speed V, it is possible to convert measured relative speed vrel of the preceding object, detected by distance sensor system 3, into an absolute speed, so that the absolute speed of the preceding vehicle is also determinable. A brake-pedal sensor 6 is also provided, which detects an actuation of the brake pedal, as well as the intensity of the brake-pedal actuation, and relays this in the form of an input signal to input circuit 2 of longitudinal control device 1. The input variables, which were supplied to longitudinal control device 1 with the aid of input circuit 2, are supplied by a data-exchange device 7 to a calculation device 8. For instance, calculation device 8 may be a microprocessor or a signal processor on which the method of the present invention runs in the form of a program. From the input variables fed to longitudinal control device 1, in accordance with the program running, calculation device 8 ascertains output variables that are output with the aid of data-exchange device 7 to an output circuit 9. The output variables of longitudinal control device 1 are output by output circuit 9 to downstream actuators.

If, as a function of the input variables, it is determined with the aid of the longitudinal control method running on calculation device 8 that the host vehicle should be accelerated, then an output variable is output via output circuit 9 to a power-regulating control element 10 of the drive device. In the case of a mixture-compressing internal combustion engine, this power-regulating control element 10 may be an electrically actuated throttle valve, for example. In the case of an air-compressing internal combustion engine, it is possible for the power-regulating control element to be implemented as a fuel-quantity metering device of a fuel-injection device. Moreover, power-regulating control element 10 may also be a control circuit for an electric motor for drive purposes. If it is determined that the vehicle is traveling too fast and must be decelerated, a manipulated variable is output via output circuit 9 to deceleration devices 11 of the vehicle. For example, this manipulated variable is fed to a brake-control device 11 which, from it, generates a braking pressure or a braking force that controls the braking devices of the vehicle so that the vehicle is slowed down.

It is further provided that output circuit 9 is able to output a drive-away prompt signal to a drive-away prompt device 12. If it is detected that, because of a stopped, preceding vehicle, the host vehicle has been braked to a standstill, and if it is further detected that the preceding vehicle is driving away again and the host vehicle may be accelerated, then before the host vehicle is accelerated, the driver is prompted to actuate a drive-away confirmation. This ensures that no persons or objects which are possibly not detectable by distance sensor system 3 are directly in front of the host vehicle. Since the driver of the vehicle still retains the responsibility for guiding the vehicle, and the longitudinal control system having the stop and drive-away functions merely assumes assistance functions, a drive-away confirmation by the driver is necessary so that the driver is able to signal to the system that he/she has the traffic situation under control and it is possible for the vehicle to drive away.

This prompt to the driver to output a drive-away confirmation is generated by drive-away prompt device 12. For example, it may be an indicator lamp within visual range of the driver which lights up, or a plain text display in the instrument cluster of the vehicle on which a symbol or a text is output. Moreover, this drive-away prompt device 12 may be an acoustical system which uses a warning tone or a voice output to prompt the driver for a drive-away confirmation. It is likewise possible for the drive-away prompt to be a combination of visual and acoustical prompts. If the traffic-jam following assistant is activated and, because of a stopped, preceding vehicle, the host vehicle is likewise at a standstill, and the preceding vehicle drives away again, then drive-away prompt device 12 is activated and there is a wait until the driver emits a drive-away confirmation with the aid of brake-pedal sensor 6.

The drive-away confirmation, which is detected by brake-pedal sensor 6, may be the actuation of the brake pedal, for example, or else the release of the brake pedal until it is returned to the neutral position again. It is further possible that the brake pedal must be displaced so far that a minimum pedal travel of the brake pedal would have to be covered, so as not to evaluate an inadvertent, light touching of the brake pedal as a drive-away confirmation. The safety of the system against inadvertent actuation would thereby be increased. Furthermore, it is possible that brake pedal 6 must be displaced out of the neutral position for a predetermined minimum actuation time, or must be displaced further than a predetermined minimum pedal travel for this minimum actuation time.

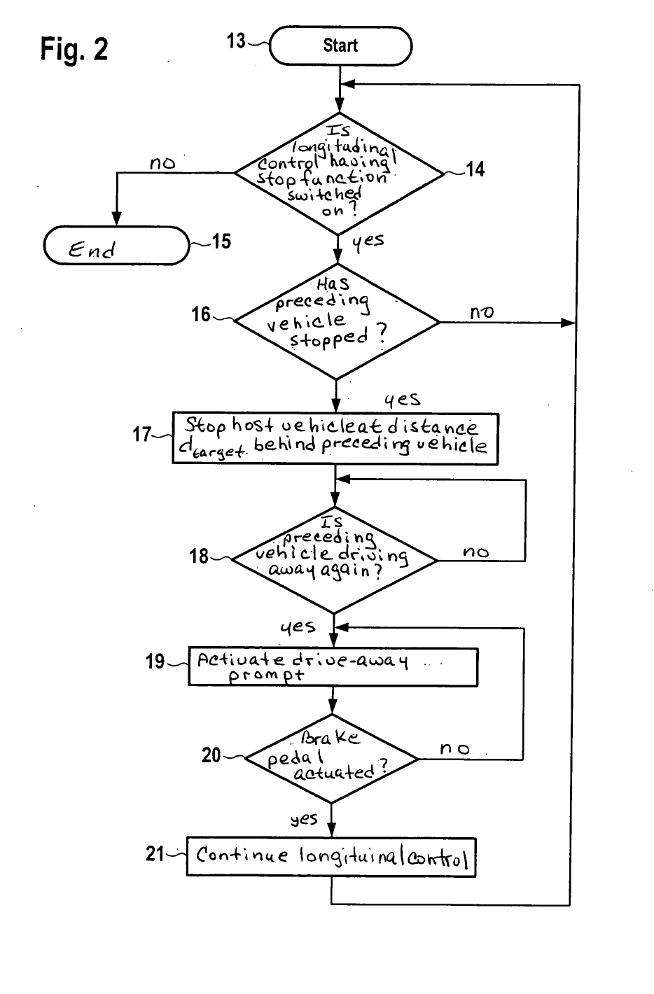

FIG. 2 shows a flowchart of an example implementation of the method according to the present invention. It begins in step 13 at start, whereupon in step 14, the condition must be met that the longitudinal control having the stop function (traffic-jam following assistant) is switched on. If this is not the case, the sequence branches to step 15, where the method is ended. If the longitudinal control having the stop function is satisfied according to step 14, the method is continued in step 16, in which it is checked whether a preceding vehicle has stopped. This is determined by distance sensor system 3, with the inclusion of the host vehicle speed V of speed sensor 5. If the preceding vehicle has not stopped, but rather is still moving, then step 16 branches to no, and the method is continued in step 14. If it is determined in step 16 that the preceding vehicle has stopped, then in step 17, the host vehicle is stopped at a distance dtarget behind the preceding stopped vehicle. This is accomplished using command signals which control the deceleration means that intervene in deceleration devices 11 of the vehicle, these command signals being calculated by calculation device 8 as a function of the detected measured quantities of distance sensor system 3, an input target distance dtarget being predefinable with the aid of operating device 4, as well as the host speed V of speed sensor 5. As long as the preceding vehicle remains at a standstill, step 18 branches to no, and the method is continued as a loop to step 18, so that a wait loop is formed. If it is detected that the preceding vehicle is driving away again, the method branches to step 19 in which a drive-away prompt is output to the driver by longitudinal control device 1 with the aid of drive-away prompt device 12. As long as the brake pedal is not actuated, step 20 branches to no, so that again a wait loop is formed in which the drive-away prompt remains active and the longitudinal control device waits for actuation of the brake pedal by the driver. If in step 20, it is detected that a drive-away confirmation was given using the brake pedal, then the method is continued in step 21 in which the longitudinal control is resumed, and a setpoint speed is adjusted as a function of distance D to the preceding vehicle and relative speed Vrel of the preceding vehicle with respect to the host vehicle.

1-7. (canceled)

8. A system for automatic longitudinal control of a host motor vehicle, comprising:
a distance sensor that ascertains at least one of a relative distance of the host vehicle to a preceding vehicle and a relative speed of the host vehicle with respect to the preceding vehicle;
a calculation device for ascertaining, based on the at least one of the relative distance and the relative speed, whether the preceding vehicle has stopped, and if the preceding vehicle has stopped, controlling the host vehicle to stop at a predetermined target distance behind the preceding vehicle; and
a drive-away prompt device for outputting a drive-away prompt signal to a driver of the host vehicle when it is detected that the preceding vehicle is driving away again, wherein the drive-away prompt signal prompts the driver of the host vehicle to actuate a drive-away confirmation device, and wherein the drive-away confirmation device is a brake pedal, and wherein the host vehicle is enabled to drive away again only if the drive-away confirmation device is actuated after the drive-away prompt signal has been outputted.

9. The device as recited in claim 8, wherein the host vehicle is enabled to drive away again automatically after the drive-away prompt signal has been outputted when the driver displaces the brake pedal from a neutral position.

10. The device as recited in claim 8, wherein the host vehicle is enabled to drive away again automatically after the drive-away prompt signal has been outputted when the driver releases the brake pedal.

11. The device as recited in claim 8, wherein the host vehicle is enabled to drive away again automatically after the drive-away prompt signal has been outputted when a predetermined minimum travel of the brake pedal has been exceeded.

12. The device as recited in claim 8, wherein the host vehicle is enabled to drive away again automatically after the drive-away prompt signal has been outputted when a predetermined minimum pedal force is been exceeded.

13. The device as recited in claim 8, wherein the host vehicle is enabled to drive away again automatically after the drive-away prompt signal has been outputted when the brake pedal is actuated for a time period exceeding a predetermined minimum actuation time.

14. A method for automatic longitudinal control of a host motor vehicle, comprising:
ascertaining, using a distance sensor, at least one of a relative distance of the host vehicle to a preceding vehicle and a relative speed of the host vehicle with respect to the preceding vehicle;
ascertaining, using a calculation device and based on the at least one of the relative distance and the relative speed, whether the preceding vehicle has stopped, and if the preceding vehicle has stopped, controlling the host vehicle to stop at a predetermined target distance behind the preceding vehicle; and
outputting, using a drive-away prompt device, a drive-away prompt signal to a driver of the host vehicle when it is detected that the preceding vehicle is driving away again, wherein the drive-away prompt signal prompts the driver of the host vehicle to actuate a drive-away confirmation device, and wherein the drive-away confirmation device is a brake pedal, and wherein the host vehicle is enabled to drive away again only if the drive-away confirmation device is actuated after the drive-away prompt signal has been outputted.
